(19) United States
(12) Patent Application Publication
(10) Pub. No.: US 2006/0220530 A1
(43) Pub. Date: Oct. 5, 2006

(54) Organic electroluminescent display panel

(75) Inventor: Chung-Chun Lee, Lunbei Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/202,726

(22) Filed: Aug. 12, 2005

(30) Foreign Application Priority Data
Mar. 31, 2005 (TW) 94110298

(51) Int. Cl. H05B 33/08; H05B 33/00

(52) U.S. Cl. 313/500; 313/505; 313/501

(57) ABSTRACT

An organic electroluminescent display (OLED) panel includes a substrate having a first sub-pixel area, a second sub-pixel area, an organic electroluminescent device disposed on the substrate for generating light, and a first optical film and a second optical film disposed on the first sub-pixel area and the second sub-pixel area respectively. The light from the organic electroluminescent device produces a first color light and a second color light in the first sub-pixel area and the second sub-pixel area, respectively, after passing through optical films. The area of the first optical film is different from that of the second optical film.

### BACKGROUND

The invention relates to a display panel, particularly an organic electroluminescent display panel.

Organic materials have been widely applied in various circuit devices. An organic electroluminescent display panel (OLED) made from organic materials has advantages of simple structure, excellent working temperature, contrast and viewing angle with light-emitting diode (LED) communication and luminescent characteristics.

The full-color techniques used most in the organic electroluminescent display panel industry can be approximately separated into an evaporation process of red-green-blue side-by-side pattern deposition and a process of color filters and white light (CFA). Because the latter requires only a display component for producing white light on the substrate and does not need display panels for generating red, green and blue colors, a mask is not necessary, and consequently the manufacturing processes is simplified. Moreover, without restricting the size of the mask, the picture quality and the sophistication of the display panels are further enhanced. Without requiring color matching and the relevant positioning during deposition of the display components, production can be increased. Therefore, this structure of color filters and white light becomes a main strand of the organic electroluminescent display panel industry nowadays.

FIG. 1 is a conventional organic electroluminescent display panel. According to FIG. 1, an organic electroluminescent display panel 10 comprises a substrate 12 with a plurality of pixels thereon. For brevity, only one pixel is given as an example in FIG. 1. The pixel comprises a first sub-pixel area 20, a second sub-pixel area 30 and a third sub-pixel area 40 on a substrate 12. A display component 14 disposed on the substrate 12, such as an organic electroluminescent display component, generates white light. The first pixel area 20, the second pixel area 30 and the third pixel area 40 comprises a red color filter 22, a green color filter 24 and a blue color filter 26, respectively, on display component 14. The white light from the display component 14 passes through the red color filter 22, the green color filter 24 and the blue color filter 26 producing red, green and blue light, respectively. Then, images are displayed.

The red, green and blue light, however, typically have different intensities due to the characteristics of the color filter materials. Thus, color shift occurs in displayed images due to the combination of red, green and blue. For example, assuming a large decrease of luminosity occurs after the light passes through red color filter 22 and the blue color filter 26 (i.e. the green light from the pixel has comparatively higher intensity), the light is actually formed white with green by driving the display component 14 with the same electric field or current intensity when the display component 10 is intended to display white light. Thus, the display quality suffers.

Conventionally, there are also some methods to resolve the color-shift problems. For example, light-color balances after the light passing through filters can be improved by selectively increasing electric current of the color sub-pixel areas on the display component 14 to output with higher luminosity. This method, however, suffers the drawback of rapidly aging display components and shortening the lifespan of the display panel 10 for increasing electric currents to overcome chromatic aberration.

Thus, a novel organic electroluminescent display panel is desired to solve conventional problems of light-color imbalance.

### SUMMARY

An organic electroluminescent display panel with hue balance is provided.

An embodiment of the organic electroluminescent display panel comprises a substrate having a first sub-pixel area and a second sub-pixel area; an organic electroluminescent device disposed on the substrate for emitting light; at least one first optical film disposed on the first sub-pixel area for generating a first color light from the emitted light of the organic electroluminescent device; and at least one second optical film disposed on the second sub-pixel area for generating a second color light from the emitted light of the organic electroluminescent device.

The first optical film has an area different from that of the second optical film.

### DESCRIPTION OF THE DRAWINGS

Organic electroluminescent display panels will become more fully understood from the detailed description given hereinbelow and the accompanying drawings, given by way of illustration only and thus not intended to be limitative of the invention.

FIG. 1 is a conventional organic electroluminescent display panel.

FIG. 2 is an embodiment of an organic electroluminescent display panel.

FIG. 3 is an embodiment of an organic electroluminescent display panel.

FIG. 4 is an embodiment of an organic electroluminescent display panel.

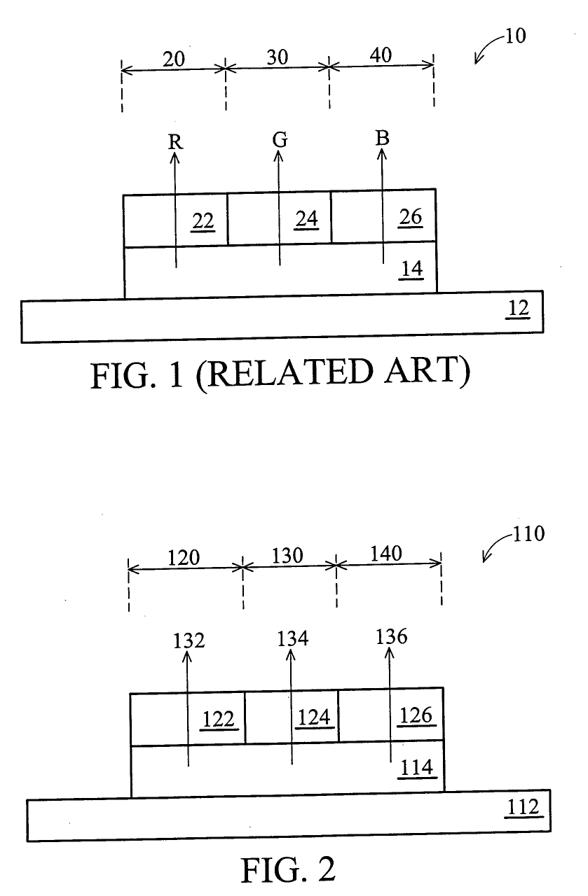

### DETAILED DESCRIPTION

An organic electroluminescent display panel will be described in greater detail in the following. FIG. 2 illustrates an embodiment of the organic electroluminescent display panel. Referring to FIG. 2, an organic electroluminescent display panel 110 comprises a substrate 112 having a first sub-pixel area 120, a second sub-pixel area 130 and a third sub-pixel area 140 thereon. The substrate 112 actually has several pixels thereon, but, for brevity, only one pixel is shown in FIG. 2.

A display component 114 is disposed on the substrate 112 for emitting light. In an embodiment of the invention, the display component 114 is an organic electroluminescent display device for producing white light, the invention is, however, not limited to this. The organic electroluminescent display device can also produce other colors, such as green, red, blue or orange etc.

A first optical film 122, a second optical film 124 and a third optical film 126 are disposed in the first sub-pixel area 120, the second sub-pixel area 130 and the third sub-pixel area 140, respectively, on display component 114. The light from the display component 114 passing through the first optical film 122, the second optical film 124 and the third optical film 126 generates a first color light 132, a second color light 134 and a third color light 136, respectively. These color lights are combined to display images.

In some embodiments of the invention, the first optical film 122, the second optical film 124 and the third optical film 126 are color filters with different colors, such as a red color filter, a green color filter or a blue color filter. Because the display component 114 is an organic electroluminescent display component producing a white light, a first red color light 132, a second green color light 134 and a third blue color light 136 are generated in the first sub-pixel area 120, the second sub-pixel area 130 and the third sub-pixel 140, respectively, after a white light from the display component 114 passes upward through the first optical film 122, the second optical film 124 and the third optical film 126.

The display component 114, the first optical film 122, the second optical film 124 and the third optical film 126 can have various combinations if desired. For example, the first optical film 122, the second optical film 124 and the third optical film 126 can be different color filters or color change (CCM) layers. The display component 114 is not limited to be a white-light organic electroluminescent display component and can be other colors. For example, the display component 114 is a blue-color display component, while the first optical film 122 and the third optical film 126 are color change layers by changing short-wavelength blue into long-wavelength red and green, respectively, and the second optical film is a blue color filter or a transparent optical film. These produce red, blue and green in the first pixel area 120, the second pixel area 130 and the third pixel area 140 after the light from the display component 114 passing through the first optical film 122, the second optical film 124 and the third optical film 126, respectively.

In some embodiments of the invention, a pixel of the organic electroluminescent display panel 110 can further have a fourth sub-pixel area (not shown) despite the first sub-pixel area 120, the second sub-pixel area 130 and the third sub-pixel area 140. The display component 114 can produce a fourth color light in the fourth sub-pixel area which can have a fourth optical film (such as a filter, a color change layer or combination thereof) or none.

It is noted that at least one of the optical films in the invention (the first optical film 122, the second optical film 124 and the third optical film 126) has a different area. Thus, desired commission internationale d'Eclairage (CIE) coordinates from a combination of red, green and blue in the same electric field of one pixel can be obtained by appropriately adjusting the luminosity of the first color light 132, the second color light 134 and the third color light 136.

Assuming the brightness of the second color light 134 (luminosity per area) is higher than that required by combining red, green and blue lights to a white light in the same electric field, the area of the second optical film 124 must be reduced or the area of the first optical film 122 and the third optical film 126 must be enlarged to fit the brightness of the second color light and balance the first color light 132, the second color light 134 and the third color light 136 to be approximately white light, i.e. the CIE coordinates are (0.31±0.03, 0.32±0.03). In addition to the varied area of each optical film, each optical film can have a different thickness or shape depending on product requirement to further improve color balance.

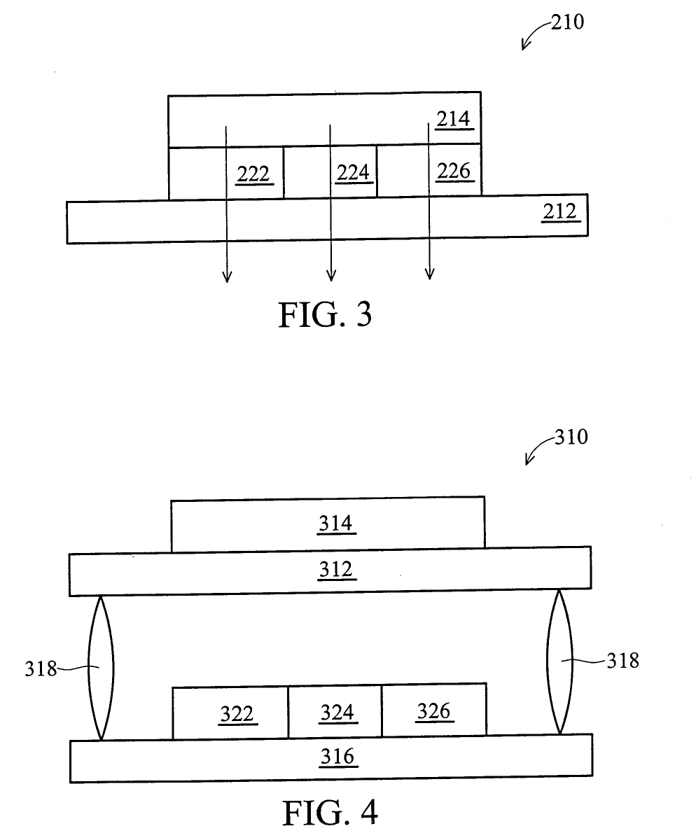

Referring to FIG. 3, an organic electroluminescent display panel 210 emits downward, compared to the described organic electroluminescent display panel 110. Hence, the first optical film 222, the second optical film 224 and the third optical film 226 are disposed beneath the display component 214. The substrate 212 is a transparent material, such as glass. The theory is the same as described except that the emission direction is altered. Thus, it should be readily understood by those skilled in the art.

Referring to FIG. 4, the display component 314 is disposed on the substrate 312, and the first optical film 322, the second optical film 324 and the third optical film 326 are on the other substrate 316. Both the substrate 312 and substrate 316 are transparent substrate, such as glass, and a glue layer 318 disposed between the substrate 312 and 316 comprises a binding material, such as a UV glue, to adheres the substrates 312 and 316. The theory is the same with previously described except that the optical film is disposed on a different substrate. Thus, it should be readily understood by those skilled in the art.

The invention provides an organic electroluminescent display panel with different sub-pixel areas to achieve hue balance by adjusting each color light to have approximately the same intensity and to improve display quality. Moreover, it is not necessary to apply an additional electric field to the display component, thereby further attending the lifespan of the organic electroluminescent display panel.

While the invention has been described by way of example and in terms of preferred embodiment, it is to be understood that the invention is not limited thereto. To the contrary, it is intended to cover various modifications and similar arrangements (as would be apparent to those skilled in the art) . Therefore, the scope of the appended claims should be accorded the broadest interpretation to encompass all such modifications and similar arrangements.

What is claimed is:

1. An organic electroluminescent display panel comprising:
a substrate having a first sub-pixel area and a second sub-pixel area;
an organic electroluminescent device disposed on the substrate for emitting light;
at least one first optical film disposed on the first sub-pixel area for generating a first color light from the emitted light of the organic electroluminescent device; and
at least one second optical film disposed on the second sub-pixel area for generating a second color light from the emitted light of the organic electroluminescent device,
wherein the first optical film has an area different from that of the second optical film.

2. The organic electroluminescent display panel as claimed in claim 1, wherein the first optical film has a thickness different from that of the second optical film.

3. The organic electroluminescent display panel as claimed in claim 1, wherein the first optical film has a shape different from that of the second optical film.

4. The organic electroluminescent display panel as claimed in claim 1, further comprising a third optical film disposed on a third sub-pixel area on the substrate for generating a third color light from the emitted light of the organic electroluminescent device.

5. The organic electroluminescent display panel as claimed in claim 1, wherein the light emitted from the organic electroluminescent device is substantially white.

6. The organic electroluminescent display panel as claimed in claim 5, wherein the first color light, the second color light and the third color light result in a white-light color with CIE coordinates of (0.31±0.03, 0.32±0.03).

7. The organic electroluminescent display panel as claimed in claim 4, further comprising a fourth sub-pixel area on the substrate for generating a fourth color light from the emitted light of the organic electroluminescent device.

8. The organic electroluminescent display panel as claimed in claim 7, further comprising a fourth optical film disposed on the fourth sub-pixel area of the organic electroluminescent device.

9. The organic electroluminescent display panel as claimed in claim 7, further comprising a fourth optical color change layer disposed on the fourth sub-pixel area of the organic electroluminescent device.

10. The organic electroluminescent display panel as claimed in claim 4, wherein the first color light, the second color light, and the third color light are red (R), green (G), and blue (B) light, respectively.

11. The organic electroluminescent display panel as claimed in claim 10, wherein the second optical film corresponding to the green light has an area smaller than those of the first and third optical films.

12. The organic electroluminescent display panel as claimed in claim 10, wherein the second optical film corresponding to the green light is thicker than the first and third optical films.

13. The organic electroluminescent display as claimed in claim 1, wherein at least one of the first optical film and the second optical film is selected from a color filter, a color change layer, or a combination thereof.
